(19) United States
(12) Patent Application Publication
(10) Pub. No.: US 2012/0136809 A1
(43) Pub. Date: May 31, 2012

(54) METHOD OF CREATING A PRICING SCHEDULE FOR USE BY A PRICING SYSTEM

(76) Inventors: Michael C. Cannata, Bloomingdale, IL (US); Charles J. Cannata, Shawnee, KS (US)

(21) Appl. No.: 13/363,969

(22) Filed: Feb. 1, 2012

Related U.S. Application Data
(63) Continuation-in-part of application No. 12/229,765, filed on Aug. 27, 2008.

(51) Int. Cl. G06Q 30/06

(52) U.S. Cl. 705/400

(57) ABSTRACT

A method of creating a per quantity price for an item for use by a price management system includes the step of utilizing a computer that includes relational database software. The method also includes the steps of determining a final price (FP) for the item and adjusting the FP by a slope quantity percent (SQP) that is based on a quantity of the item sold and on data stored on the computer to arrive at a pre-slope price (PSP). The method further includes the steps of identifying a benchmark price (BP) for the item, calculating a base quantity percent (BQP) for the item based on the PSP and BP, and providing the BQP for the item to the price management system for use in pricing orders for that item.

### CROSS REFERENCE TO RELATED APPLICATIONS

This application is a continuation-in-part of U.S. patent application Ser. No. 12/229,765, filed Aug. 27, 2008, the entirety of which is hereby incorporated by reference.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to a method of creating a holistic pricing program for use by a pharmaceutical pricing system and other similar pricing systems.

2. Description of the Background of the Invention

Providing prescription drugs to patients involves a complex system of drug distribution that includes a number of players, including manufacturers, wholesalers, and retail pharmacies, both brick and mortar and web-based. Each of these players participates in the pricing of generic and brand name drugs as purchasers or providers and sometimes both; therefore, the pricing of prescription drugs is highly complex.

The supply chain for any prescription drug is as follows: manufacturer to wholesaler; wholesaler to pharmacy; and pharmacy to patient. Wholesaler may refer to any entity that purchases drugs from manufacturers in order to distribute to a retailer before the drugs are dispensed to a patient. Retailer pharmacies include any establishment that dispenses prescription drugs to patients and to which pricing is a common consideration. Throughout the supply chain, there are many factors that can impact pricing for pharmacies and patients, namely:
Number of manufacturers making a particular drug;
Supply shortages or surpluses for materials used to make a drug;
Demand in a market place for a drug;
Newness of a drug;
Proximity to a brand's patent expiration date and timing of generic replacement;
Likelihood that a drug is covered by insurance or another third party;
Type of drug (e.g., vanity drugs like Botox or Viagra carry a higher price);
Maximum allowable cost each third party assigns to a covered drug. The maximum allowable cost is a reimbursement ceiling and can vary across third parties in relation to the same drug.
   These factors, along with each participant's interpretation of these factors, may vary or fluctuate as frequently as hourly, resulting in a complex and often confusing and speculative pricing process for pharmacies. The above factors seldom, if ever, negatively affect manufacturers or wholesalers because they set pricing in real time as factors change. Pharmacies, on the other hand, need to manage a patient's historic pricing experience, the cost of in-stock inventory versus new inventory that may need to be ordered at a higher cost, and how competition is responding to changes in the above factors.

For the purposes of this application, retail pharmacies may be classified as mass merchandisers, chain pharmacies, and independent. Mass merchandisers include pharmacies that are operated by retailers whose primary business is something other than pharmacy (e.g., Wal-Mart, Target, and grocery stores). Chain pharmacies include pharmacies with multiple locations whose primary business is the providing of drugs or related services to patients or clients (e.g., Walgreens, Rite Aid, and CVS). Independent are those pharmacies that are independently owned and may include an individual pharmacy or groups of pharmacies.

Finally, the pharmacy sells the drug to a consumer at a price that includes its drug inventory acquisition cost from the wholesaler, operating costs, and hopefully a profit.

In summary, there are many complex factors that should be considered before establishing a price for a drug sold to a consumer. Further, such factors may fluctuate over time, for example, if a new brand name drug or a new generic drug is introduced, it will also affect the pricing of drugs. While there are a number of benchmark pricing values available today to pharmacies, such as average wholesale price, a proactive pricing service that responds to trends in the market on a per drug or per national drug code basis, takes into account geo-centric nuances and manager strategies, and automatically adjusts pricing in the pharmacy drug management system does not exist. Consequently, a need exists for a more efficient and reliable way of providing such information to pharmaceutical pricing systems.

### SUMMARY OF THE INVENTION

In one aspect of the invention, a method of creating a per quantity price for an item for use by a price management system comprises the step of utilizing a computer that includes relational database software. The method also comprises the steps of determining a final price (FP) for the item and adjusting the FP by a slope quantity percent (SQP) that is based on a quantity of the item sold and on data stored on the computer to arrive at a pre-slope price (PSP). The method further comprises the steps of identifying a benchmark price (BP) for the item, calculating a base quantity percent (BQP) for the item based on the PSP and BP, and providing the BQP for the item to the price management system for use in pricing orders for that item.

In another aspect of the invention, a method of maximizing a reimbursement price for an item for use by a price management system includes the step of utilizing a computer that includes relational database software. The method also includes the step of receiving data, wherein the data contains a listing of items where a reimbursement amount associated with each item listed in the data is equal to a usual and customary (U&C) price for the item. The method further comprises the steps of calculating an adjusted U&C price, wherein the adjusted U&C price is equal to the U&C price multiplied by an adjustment factor stored on the computer, and outputting the adjusted U&C price to the price management system.

In a further aspect of the invention, a method of determining an acquisition cost based price for an item for use by a price management system comprises the step of utilizing a computer that includes relational database software. The method also comprises the step of receiving data, wherein the data contains a listing of items and an acquisition cost and a popularity ranking associated with each item listed in the data. The method further comprises the steps of retrieving an adjustment amount for a popularity range from stored data on the computer and comparing the popularity ranking for each item in the data with the popularity range. The method comprises the steps of calculating the acquisition cost based price for those items where the popularity ranking is within the popularity range, wherein the acquisition cost based price is equal to the acquisition cost of the item multiplied by the adjustment amount and outputting the acquisition cost based price to the price management system. The acquisition cost based price is not calculated for the item if the popularity ranking of the item does not fall within the popularity range.

In another aspect of the invention, a method of determining a ranked based price for an item for use by a price management system includes the step of utilizing a computer that includes relational database software to perform. The method also comprises the steps of receiving data, wherein the data contains a listing of items, a popularity ranking for each item, and a median price for each item and for each market type, and retrieving a popularity range, a pricing strategy, and an adjustment amount from stored data on the computer. The method further includes the steps of comparing the popularity ranking for each item in the data with the popularity range and calculating a ranked based price based on the popularity range, the pricing strategy, and the adjustment amount for those items where the popularity ranking is within the popularity range and outputting the ranked based price to the price management system. The ranked based price is not calculated for an item if the popularity ranking of the item does not fall within the popularity range.

Other aspects and advantages of the present invention will become apparent upon consideration of the following detailed description.

### BRIEF DESCRIPTION OF THE DRAWINGS

FIG. 1 is a flowchart that can be executed to create a pricing schedule for use by a pricing system;

FIG. 2 is a block diagram that shows an example of a system that is capable of implementing the flowchart of FIG. 1;

FIG. 3 illustrates example pricing tables and an example discount table;

FIG. 4 is an example screen shot that shows market data for an item;

FIG. 5 is an example pricefile;

FIG. 6 is a flowchart of another embodiment of the pricing schedule of FIG. 1;

FIG. 6A is a flowchart showing the steps by which data is processed as shown in FIG. 6;

FIG. 7 is a flowchart of another embodiment of the pricing schedule of FIG. 1;

FIG. 8 is a flow chart that illustrates the process by which a final price is determined;

FIG. 9 is a flowchart that demonstrates the process by which a NDC specific price is determined;

FIG. 9A is an example screen shot of a NDC specific price user interface;

FIG. 10 is a flowchart that shows the process by which a market price is determined;

FIG. 11 is a flowchart that illustrates the process by which a rank based price is determined;

FIG. 11A is an example screen shot of the rank based price user interface;

FIG. 12 is a flowchart that demonstrates the process by which a reimbursement protection price is determined;

FIG. 12A is an example screen shot of customer data that may be provided for use with the reimbursement protection price determination;

FIG. 13 is a flowchart that shows the process by which an acquisition protection price is determined; and

FIG. 13A is an example screen shot of customer settings that may be provided for use with the acquisition protection price determination.

### DETAILED DESCRIPTION

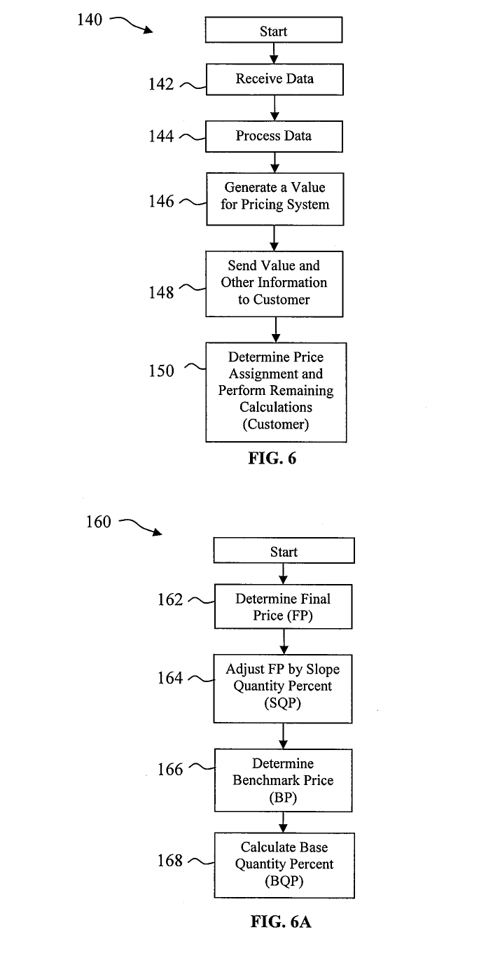

The invention disclosed herein relates in general to three basic process steps. Turning to FIG. 6, a flowchart 140 demonstrating the overall process by which a pricing schedule is produced is shown. First, data comprising market data and end user or customer data for an item is obtained at a block 142 and interpreted by the system to generate a normalized or slope adjusted price for the item at a block 144. Next, at a block 146, the relationship between the slope adjusted price and relative values assigned to the item are interpreted to arrive at a value that can be properly used by an end user pricing system to price the item at retail. The value and other pertinent information, such as the item associated with the value, are sent to the end user at a block 148. Finally, at a block 150, the appropriate price assignment based on the sent information and the final execution of any remaining calculations are performed by the end user pricing system.

FIG. 6A is a flowchart 160 that depicts the process by which data is processed at block 144 in FIG. 6. First, at a block 162, a final price (“FP”) is determined for an item. As discussed in more detail below, the FP may be determined based on several different components. Next, at a block 164, the FP is adjusted by a slope quantity percent (“SQP”) that is based on a quantity of the item and on the market and customer data received at block 142 of FIG. 6, which has subsequently been stored on the computer, to arrive at a pre-slope price (“PSP”). Typically, the quantity used is the most sold quantity of the item or, in the case of prescribed drugs, the most prescribed quantity. Next, at a block 166 a benchmark price (“BP”) is determined. At a block 168, a base quantity percent (“BQP”) is calculated based on the PSP and BP for the item. The BQP is then sent to the end user's pricing system as shown at block 148 of FIG. 6 to be further processed by such system.

The invention disclosed herein may be utilized with any pricing system that generates a retail price. However, for illustration purposes, the invention is discussed hereinafter in terms of a pharmaceutical pricing system for drugs sold at pharmacies to retail consumers.

Turning now to the drawings, FIG. 1 illustrates a flowchart 10 of a process that can be executed to create a pricing schedule for use by a pharmaceutical pricing system to price brand name and/or generic drugs. Control begins at a block 12 that creates one or more pricing tables that are transmitted to a host pharmacy system. Each pricing table corresponds generally to a base quantity percentage, either a mark up or mark down applied to a BP, which can be associated with a particular drug. Typically, the BQP is designated by integers, e.g., a gain of 1%, 2%, 3%, etc. or a loss of 1%, 4%, 20%, etc. In one embodiment, a plurality of standard pricing tables, e.g., 55 standard pricing tables, are created a single time by the block 12, transmitted to the pharmacy, and upon acceptance by the pharmacy do not change. The pricing tables are then used repeatedly by the pricing system. In another embodiment, two pricing tables are created and transmitted to the pharmacy by the block 12. It is also contemplated that the pricing tables are created and transmitted to the pharmacy more than once.

Further, the block 12 creates a discount table. The discount table designates a discount percentage or slope quantity percentage that is applied to a drug based on the dispensed quantity of the drug. For example, if the dispensed quantity is between 30 and 35 units, wherein each unit is, for example, a single pill, tablet, dose, etc., then a discount of 4% is applied to the price of the drug. Generally, the greater the dispensed quantity of the drug, the greater the discount percentage is. For example, if the dispensed quantity is between 60 and 79, then a discount of 8% may be applied to the price of the drug. In other embodiments, the block 12 can create a plurality of different discount tables, as would be apparent to one of ordinary skill in the art.

Following the block 12, control passes to a block 14, which receives market data for one or more drugs. In one embodiment, the market data includes an industry benchmark price such as an average wholesale price (“AWP”), average manufacturer price (“AMP”), wholesale acquisition cost (“WAC”) or the like and a median sales price (“MSP”), which is based on historical sales data, for a plurality of drugs in a given geographic area or market. In general, the BP and MSP are based on a dispensed quantity of each drug known as the most prescribed quantity (“MPQ”), wherein a price per unit of the drug normally varies depending on the dispensed quantity. For example, if the dispensed quantity is 30, then a price per unit may be higher then if the dispensed quantity is 90. Such decrease in price per unit as the dispensed quantity increases is generally referred to as the discount percentage or SQP. In addition, the group of drugs included in the market data may be a subset of all the drugs sold in a particular geographic market; for example, the market data may only include the 2100 most popular drugs sold in the geographic market. Therefore, all of the drugs sold by a pharmacy within the geographic market will not necessarily be included in the market data received. However, the system may still be used for those drugs not included in the market data if certain features are enabled, as will be discussed in more detail below. Furthermore, the market data includes the popularity ranking for each drug contained in the data. The market data may be obtained from third party sources or can be developed independently. In one example, the market data may be acquired from various sources, including First DataBank, Inc. of San Bruno, Calif., and RelayHealth of Atlanta, Ga.

As stated above, the block 14 can receive the market data for a plurality of drugs in a given geographic area. The given market can be defined by a zip code, city, state, geographic region, or any other suitable definition. In one embodiment, the given geographic area is defined by the first two or three digits of the zip code and the market data is obtained for the top 2100 drugs sold in the geographic area.

The market data received during the block 14 can also include additional information, such as, a breakdown of BP and MSP data by a type of retailer and/or a type of transaction. For example, different retailers may include a chain drugstore, an independent retailer, and a mass merchandiser. Examples of the type of transaction may include sales to cash consumers or sales to third parties. Still further, the market data ranks each of the drugs according to the sales position by volume or total sales of the drug in the given geographic area. The inclusion of drug rankings is an important feature of the market data as several of the system's components that are discussed hereinafter use the rankings to generate a price value that is used by the system. After the block 14, control passes to a block 16, which processes the market data received at the block 14 to assign or associate a pricing table to each drug. More specifically, the market data is processed according to a formula that calculates a BQP, which is then subjected to a sliding scale. In the present example, the BQP for a quantity of a drug is calculated using the following equation: [MSP/(SQP)]/BP=BQP, wherein the SQP is a discount rate obtained from the discount table created at the block 12. In one embodiment, the block 14 rounds the BQP to the nearest integer and assigns the drug to a corresponding pricing table based on the rounded BQP. In other embodiments, the BQP can be left as a fraction and assigned to a pricing table, as would be apparent to one of ordinary skill.

Next, control passes to a block 18, where an industry recognized unique identifier is assigned to each drug the system prices. The unique identifiers may, for example, include a generic product identifier (“GPI”), a universal product code (“UPC”), a national drug code (“NDC”), and the like. The actual unique identifiers obtained may depend on the source of such information. Generally, the unique identifiers are specific to a drug, manufacturer, dose form, and/or package size.

A block 20 processes the unique identifiers for the drugs so that each drug has a standardized identifier in a consistent format. Such standardized identifiers should be in a format that can be used across different pharmaceutical pricing systems, such as with Pharmaserv®, a product offered by McKesson Pharmacy Systems of Livonia, Mich., or other pricing and accounting systems offered by such companies as Rx30 of Ocoee, Fla., QS/1 of Spartanburg, S.C., and Compusolv of Highland, Ill. In one embodiment, a form of the NDC number, such as an eleven-digit NDC number, is used as the standardized identifier. However, in other embodiments, the GPI, UPC, or modifications thereof can be used as the standardized identifier.

A block 22 creates a current pricefile that associates the standardized identifier for each drug with a pricing table in accordance with the processing performed by the block 16. In one embodiment, the block 22 may compare a previous pricefile, e.g., a pricefile from a previous month, with the current pricefile and identify drugs that were on the previous pricefile but not in the current pricefile. Such drugs, e.g., drugs that fell out of the top 2100 drugs sold in a geographic area, can be added to the current pricefile and associated with a default pricing table, as will be described in more detail hereinafter. Alternatively, any new drugs in the area, e.g., drugs that were not members of the top 2100 drugs but now are, will be associated with some other pricing table.

Following the block 22, a block 24 can be implemented, depending on the host system requirements, to prepare a pharmaceutical pricing system of a customer before loading the current pricefile. The block 24 processes the pharmaceutical pricing system of the customer by analyzing and storing existing drug records, comparing the existing drug records to the previous pricefile and/or the current pricefile, and deleting outdated or irrelevant drug records from the pharmaceutical pricing system. Following the block 24, a block 26 can load the current pricefile to the pharmaceutical pricing system. The blocks 24 and 26 can be modified in other embodiments, e.g., the block 24 can be omitted and the block 26 performed to load the current pricefile and overwrite any existing data.

After the current pricefile is loaded to the pharmaceutical pricing system of the customer, a block 28 can calculate the price of one or more drugs by utilizing the pharmaceutical pricing system. In one example, the following formula is used to calculate the price: BP*BQP, wherein the current pricefile provides a pricing table for the drug that contains the BQP, and wherein the host system applies the dispensed quantity impacted pricing formula domiciled in the pricing scheduled provided in block 12.

Referring generally to FIG. 1, the flowchart 10 may be executed repeatedly on a periodic basis to update the current pricetable and to provide the updated pricetable to the pharmaceutical pricing system for the customer. By way of illustration only, an updated pricing table can be created and loaded to the pharmaceutical pricing system on a daily, weekly, monthly, quarterly, or annual basis. In addition, the blocks 12-28 of the flowchart 10 can be omitted or modified or additional blocks may be included, as would be apparent to one of ordinary skill in the art. Alternatively or in conjunction, the order of the blocks can be rearranged or one or more of the blocks can be performed concurrently with one another.

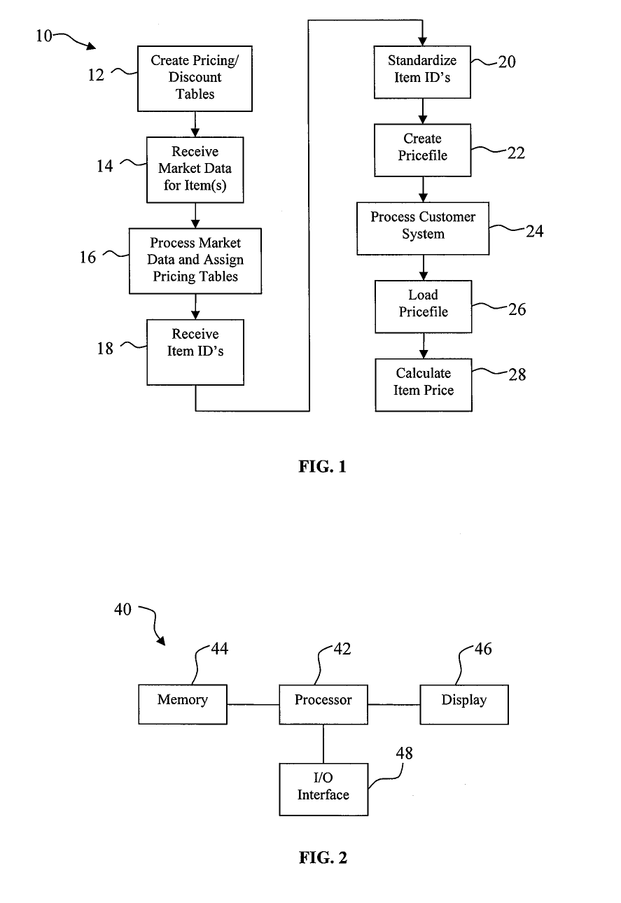

FIG. 2 shows one embodiment of a system 40 that can implement the flowchart 10 of FIG. 1. In FIG. 2, the system 40 includes a processor 42 coupled to a memory 44, a display 46, and an I/O interface 48. By way of non-limiting example, the system 40 can be implemented as a personal computer with suitable hardware and software adapted to run an appropriate operating system, e.g., Microsoft Windows, Mac OS, Linux, etc., as would be apparent to one of ordinary skill in the art. The processor 42 controls the operation of the system 40 in accordance with programming and suitable applications stored in the memory 44 and instructions received through one or more input devices (not shown) coupled to the I/O interface 48. For example, the processor 42 controls the display 46 to display information, such as market data for one or more drugs, to facilitate the manipulation of such information by a user. Programming stored by the memory 44 may include the flowchart of FIG. 1 programmed in a software language, such as Visual Basic, Java, or other language compliant with American National Standards Institute Standard 256, and suitable applications stored by the memory 44 may include relational database software such as the Windows-based Microsoft ACCESS database, as well as, ORACLE, SYBASE, and INFORMIX database software. Various examples of input/output devices (not shown) that can be coupled to the I/O interface 48 include without limitation, a keyboard, a mouse, a flash memory drive, a CD or DVD drive, a printer, etc. Further, in another example, the system 40 is configured to send information to one or more other similar or different systems via a wired or wireless connection.

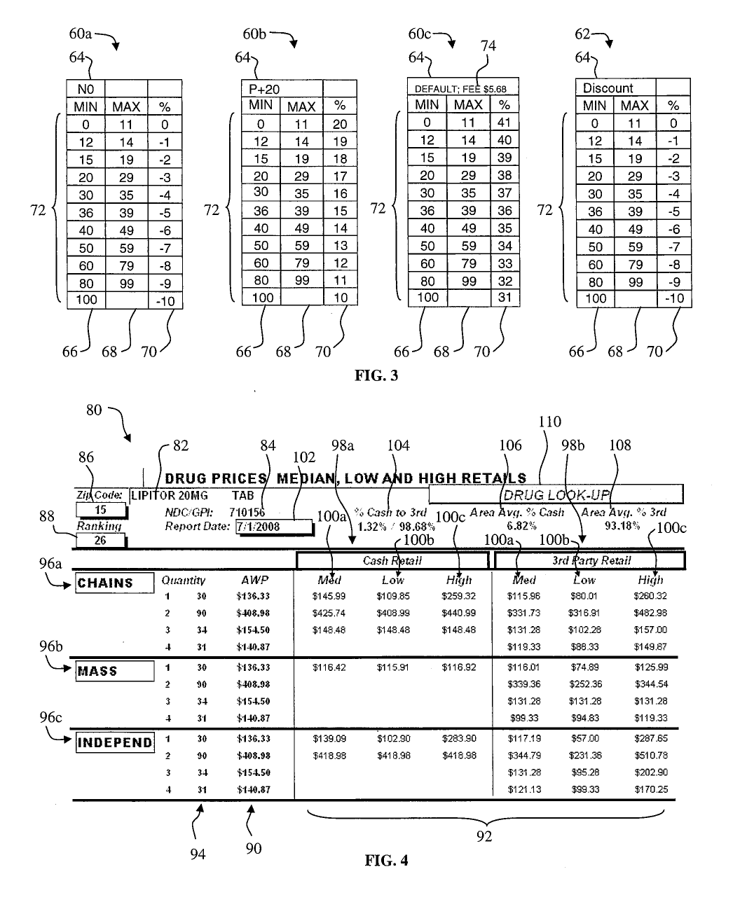

FIG. 3 shows examples of pricing tables 60a, 60b, and 60c and an example of a discount table 62 that can be created at the block 12 of FIG. 1. Referring to the pricing tables 60a-60c, each table includes a name block 64 that generally specifies an associated BQP. For example, the NO table 60a specifies a 0% BQP, the P+20 table 60b specifies a positive 20% BQP, and the DEFAULT table 60c specifies a default positive 41% BQP. Each pricing table 60a-60c also includes a MIN column 66, a MAX column 68, and a “%” column 70. The MIN column 66 and the MAX column 68 are divided into a plurality of rows 72 that designate different ranges of dispensed quantities of the drug and the “%” column 70 designates a BQP on a sliding scale for each of the different ranges of quantities. For example, in the NO table 60a, if the dispensed quantity of the drug is 30, then the BQP is −4, i.e., a multiplier of 96%. In other examples, in the P+20 table 60b, if the quantity of the drug is 60, then the BQP is 12, i.e., a multiplier of 112%, and if the quantity if greater than 100, then the BQP is 10%, i.e., a multiplier of 110%.

Referring to the DEFAULT table 60c, a fixed markup fee 74 can also be included and added to the price of the drug regardless of the dispensed quantity. In the present example, the fixed markup fee 74 is $5.68, which can be modified as desired. In one embodiment, the DEFAULT table 60c can be associated with drugs that have a BQP that lies outside of any of the other pricing tables, e.g., drugs that have a BQP greater than 200% and/or drugs that were listed in a previous pricefile but not for a current pricefile.

The discount table 62 of FIG. 3 also includes the name block 64, the MIN column 66, the MAX column 68, and the % column 70. Like the pricing tables 60a-60c, the MN column 66 and the Max column 68 of the discount table 62 are divided into a plurality of rows 72 that designate different ranges of dispensed quantities of the drug. However, in the discount table 62, the % column 70 designates a discount rate or SQP for each of the different ranges. For example, if the quantity is 30, then the discount rate is −4, i.e., a multiplier of 96%, while if the quantity is 90, then the discount rate is −9, i.e., a multiplier of 91%.

In the pricing tables 60a-60c and the discount table 62, the quantities are divided into 11 ranges and the BQP and the discount rate decrease by one percent with each increase in range. However, various modifications can be made to pricing tables 60a-60c and the discount table 62 without departing from the spirit of the present disclosure, e.g., the ranges can be modified, a fewer or a greater number of different ranges can be used, and/or the BQP and the discount rate can be increased or decreased by any fractional or integer percentage value. Further, additional pricing tables can be created that correspond to a wide range of BQP and/or a plurality of different discount tables 62 can be created.

In one embodiment, the discount table is used a single time in the block 16 of FIG. 1 and the pricing tables 60 incorporate the discount rate, as seen in the pricing tables 60a-60c, wherein the BQP mirrors the discount rates in the discount table 62 and decreases by one percentage point with each increase in range. Consequently, when the drug price is calculated at the block 34 of FIG. 1, only the BP and the BQP from the pricing tables 60 are needed because the pricing tables incorporate a sliding scale based on the discount table 62. In a different embodiment, the pricing tables may only include a base BQP, e.g., the P+20 table only includes a base BQP of 20%, wherein a discount rate or SQP from the discount table 62 is used during the block 34 of FIG. 1 to calculate the drug price for a given quantity using the following formula: BP*BQP*SQP.

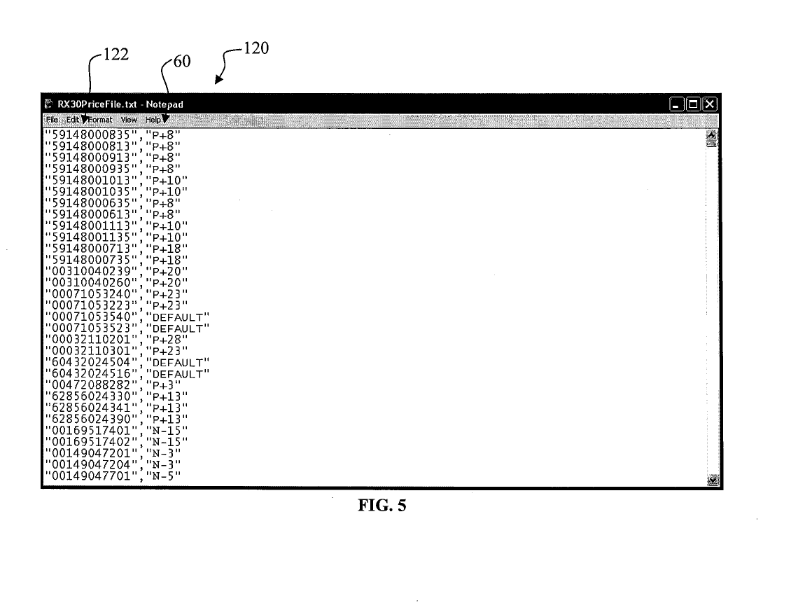

FIG. 4 illustrates an example of a screen shot 80 displayed by the system 40 of FIG. 2 that includes market information for a drug, such as the market information received by the block 14 of FIG. 1. In the screen shot 80, a box 82 lists a description of a specific drug, which in the present non-limiting example is “Lipitor 20 mg TAB.” Further, a NDC or a GPI identifier 84 for the drug is also listed. In the present embodiment, the NDC or the GPI number 84 is shown with leading zeros truncated. In other embodiments, other unique identifiers can be used, e.g., the UPC.

A box 86 lists a geographic area under consideration, which in the present example is specified by the first two digits of a zip code that defines the geographic area. A box 88 includes a specific sales ranking of the drug in the geographic area. The screen shot 60 also includes the BP (in this example AWP is used) 90 and sales information 92 for the drug. The BP 90 and sales information 92 are divided into a plurality of rows based on a column 94 that lists different quantities of the drug. Further, the BP 90 and sales information 92 is divided into a plurality of groups of rows that correspond to different types of retailers. In the present example, the screen shot 80 includes a group of rows for chain drugstores 96a, a group of rows for mass merchandisers 96b, and a group of rows for independent retailers 96c. Within each group of rows 96a-96c, the column 94 lists the four most dispensed quantities of the drug, e.g., 30, 90, 34, 31. The sales information 92 can also be divided into different columns based on a type of transaction. In FIG. 4, the sales information 92 is divided into a cash retail column 98a and a third party retail column 98b. Still further, each column 98a, 98b is divided into a MSP 100a, a low sales price 100b, and a high sales price 100c for the geographic area. The screen shot 80 also includes additional information, such as a report date 102, a cash to third party ratio 104, an area average cash percentage 106, and an area average third party ratio 108. The cash to third party ratio 104 includes two percentages, the first is the ratio for the drug overall and the second is the ratio for the drug in the geographic area. Further, the screen shot 80 includes a drug look-up button 110 that a user can click on to select a different drug, as would be apparent to a person of skill in the art. In other embodiments, the screen shot 80 can include a lesser or greater amount of information, such as other different types of transactions and an acquisition cost for a drug.

Referring to FIG. 5, a pricefile 120 is shown as generated at the block 22 of FIG. 1. Each line of the pricefile 120 includes a standardized identifier 122 for a drug associated with a pricing table 60. In the present embodiment, an 11-digit NDC number is used as the standardized identifier. However, as discussed above, in other embodiments it may be appropriate to use other standardized identifiers. The pricefile 120 in the present embodiment is a list saved as a Notepad file. However, in other embodiments, the pricefile 120 may be stored in a database, spreadsheet, text file, or any other appropriate format. In general, the format of the pricefile 120 will be compatible with the pharmaceutical pricing system of the customer. In the present embodiment, the pricefile 120 lists standardized identifiers for all of the relevant drugs in a geographic area, e.g., a list of 61,000 drugs. However, a lesser or greater amount of drugs can be listed in the pricefile 120 in other embodiments.

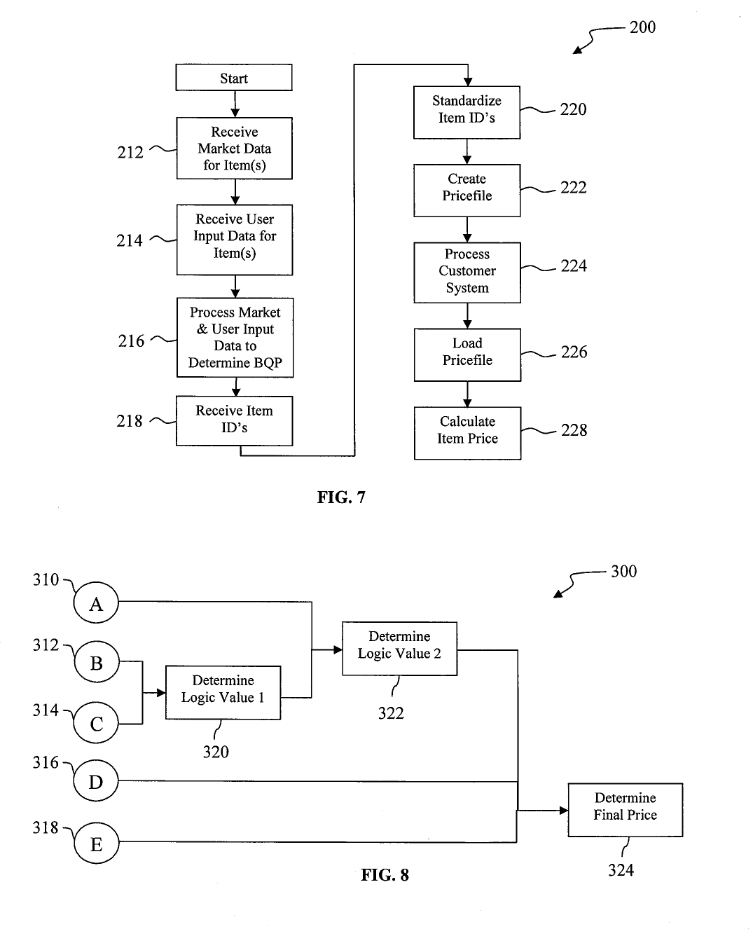

Turning to FIG. 7, a flowchart 200 illustrates another embodiment of a pricing schedule for use by a pharmaceutical pricing system to price brand name and/or generic drugs. Although presented in a specific order, the blocks discussed hereinafter may occur simultaneously or in an order different from that presented. Control begins at a block 212, which receives market data for one or more drugs. As discussed above, market data includes a benchmark price such as AWP, or other benchmark price as discussed herein, and a median sales price for a plurality of drugs in a given geographic area or market.

After the block 212, control passes to a block 214, which receives data inputted by the end user or pharmacy. The data entered by the pharmacy may include, for example, reimbursement or acquisition cost data. Following the block 214, control passes to block 216, which processes the market data received at the block 212 and the user input data received at block 214 to determine a BQP for each drug being priced. More specifically, the market and/or user input data are processed according to one or more pricing components that calculate a final price for each drug. These pricing components are discussed in more detail below. FP is then used to calculate BQP.

In one embodiment, the BQP may be used with a system that is based on a markup percentage (“MUP”) and markdown percentage (“MDP”) format rather than pricing tables. In this embodiment, if BP is greater than or equal to PSP then: MDP BQP=((BP−PSP)/BP)*(−100). If BP is less than PSP then: MUP BQP=((PSP−BP)/BP)*100.

Alternatively, BQP is used to assign a pricing table based on a sliding scale using the discount rate or SQP. In this embodiment, to determine BQP, the final price is first divided by the SQP to determine a pre-slope price. SQP is determined based on the MPQ for the drug. Next, PSP is divided by the benchmark price for the drug at its MPQ to get a percent value (“PV”). Once PV is calculated, it is used to determine BQP according to the following formulas: if BP is greater than or equal to PSP, then 1−PV, and if BP is less than PSP, then PV−1.

Next, control passes to a block 218, which assigns unique identifiers for the drugs that are being priced. As discussed above, the unique identifiers may include a GPI, UPC, NDC, and the like. A block 220 processes the unique identifiers for the drugs so that each drug has a standardized identifier in a consistent format.

A block 222 creates a current pricefile that associates the standardized identifier for each drug with a markup/markdown percentage or a pricing table in accordance with the processing performed by the block 216. The pricing table may function as the pricing schedule that is used by a pharmaceutical pricing system to calculate the price of a drug.

Following the block 222, a block 224 may be implemented to prepare a pharmaceutical pricing system of a customer before loading the current pricefile. As discussed above, the block 224 can process the pharmaceutical pricing system of the customer. Following the block 224, a block 226 can load the current pricefile to the pharmaceutical pricing system. The blocks 224 and 226 may be modified in other embodiments, e.g., the block 224 can be omitted and the block 226 performed to load the current pricefile and overwrite any existing data.

After the current pricefile is uploaded to the pharmacy, a block 228 can calculate the price of one or more drugs based on the information contained in the pricefile and the quantity of the drug to be dispensed.

In its most basic form, a price is determined as follows. Market data is received that provides a benchmark price for a MPQ of a drug (block 212) and user data is received (214), which is used together with the market data to determine a final price (block 216). The system then backs out the volume-impacted price to arrive at a price per unit of the drug based on the benchmark price and a final price (block 216). The price per unit of the drug is then associated with a BQP (block 216). Depending on the pharmacy's system, the BQP may be assigned to a markup/markdown percentage or a pricing table, which is outputted to a pricefile along with the standardized identifier associated with the drug (block 222). The pricefile is then sent to the pharmacy, which uploads the pricefile (block 226). The pharmacy reapplies the SQP based on the information provided in the pricefile received and the quantity it dispenses to a consumer to arrive at an appropriate retail price for the drug (block 228).

Turning now to FIG. 8, a flow chart 300 shows the process by which the final price is determined. Input values A 310, B 312, C 314, D 316, and E 318 are shown on the left-hand side of the flow chart. The input values A, B, C, D, and E correspond to the following pricing components, respectively: NDC specific price, market price, rank based price, reimbursement protection price, and acquisition protection price. Each pricing component will be discussed in more detail below. Depending on a pharmacy's preference, some of the values may not be available to calculate the final price associated with a specific drug. For example, if a pharmacy does not implement acquisition protection for a specific drug, then input value E 318 would not be available, and FP is determined based on the other four input values A 310, B 312, C 314, and D 316. Similarly, if rank based price and reimbursement protection price are not selected by a pharmacy for a specific drug, then FP would be calculated using input values A, B, and E.

The process by which the final price is determined is as follows. A block 320 first determines a logic value 1. Logic value 1 is equal to the input value C (rank based price) if it is available; otherwise, logic value 1 is equal to the input value B (market price). Next, a block 322 determines a logic value 2. Logic value 2 is equal to the input value A (NDC specific price) if it is available; otherwise, logic value 2 equals logic value 1. Next, a block 324 determines the final price. FP is equal to the largest of logic value 2, input value D (reimbursement protection price), and input value E (acquisition protection price). Once FP is determined, it is used in the formulas discussed above to determine the base quantity percentage.

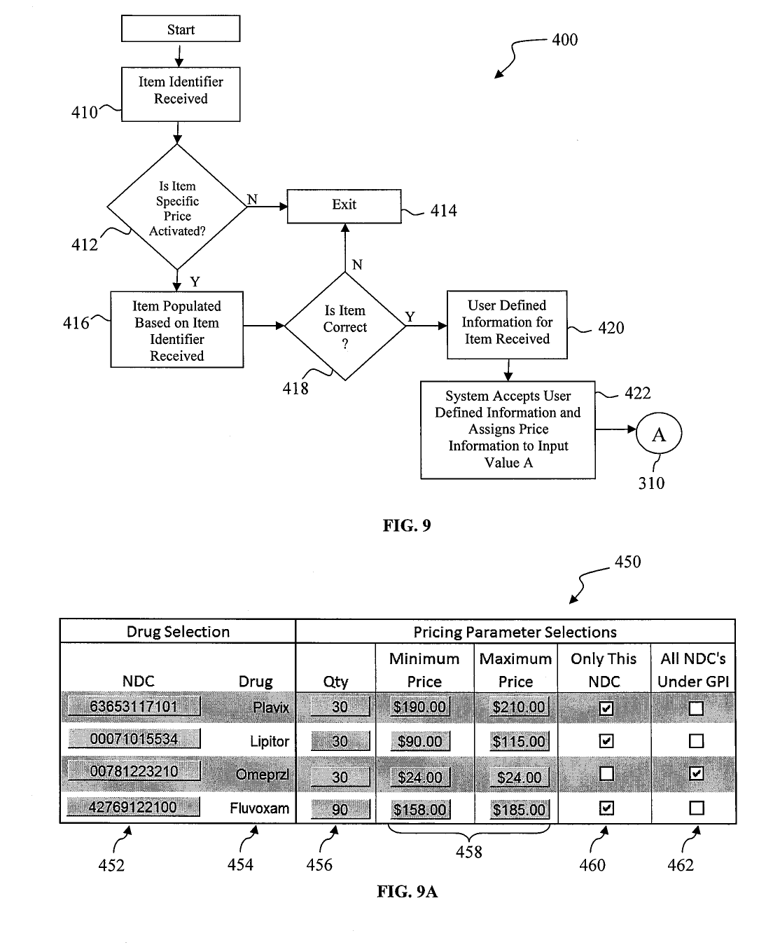

FIG. 9 is a flowchart 400 that demonstrates the process by which a NDC specific price is determined. An NDC specific price may be determined for one NDC or for all NDCs included under a specific GPI. There are several reasons a pharmacy may choose to provide a specific price, regardless of what the market data shows. The most common reason relates to how a pharmacy views narcotics being dispensed to cash consumers. Some pharmacies are concerned about the type of clientele narcotic drugs generate and wish to charge a price that is well in excess of the price being offered at other pharmacies in their market area for narcotic drugs to discourage cash consumers. Another common reason a pharmacy may choose to provide a NDC specific price is that it may want to run a special on a popular drug in the area.

The process of determining a NDC specific price begins when a NDC is entered into the system at a block 410 by a user. The system then determines at a block 412 if the NDC specific price component is activated. If the NDC specific price component has been activated, the system will populate a field with the drug name and the MPQ associated with the NDC at a block 416; otherwise, the system will exit the NDC specific price component at a block 414. At a block 418, the user verifies that the information populated by the system is correct. If the information is incorrect, the system exists at a block 414. After the information has been verified, the system at a block 420 uploads data relating to the drug associated with the NDC that has been entered by the user in the NDC specific price user interface 450 as shown in FIG. 9A. The NDC specific price user interface 450 may display the NDC 452 entered for a specific drug or a plurality of drugs and the associated drug name(s) 454 and MPQ 456. The data entered by the user may include a benchmark value (not shown) and either a specific price or a price range 458 for the drug or drugs. In addition, the user may apply the pricing the user has selected to one specific NDC 460 or all NDCs under a particular generic product indicator 462 (generic drugs often have different NDCs based on the manufacturer or package quantity). Once the data inputted by the user has been uploaded, the system at a block 422 accepts the information and the price or price range is assigned to the input value A 310. The input value A 310 may then be used to determine the final price as discussed above.

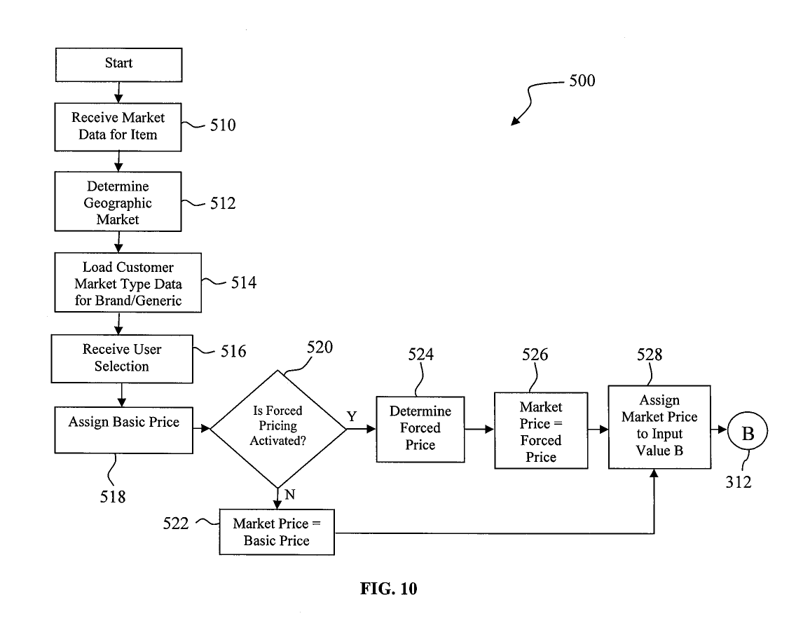

FIG. 10 is a flowchart 500, which shows the process by which a market price is determined. First, market data is received at a block 510. Next, at a block 512, the geographic market of a pharmacy is determined based on data received from the customer. The geographic location is selected by the customer during customer set-up and can be changed at any time depending on the customer's preference. The relevant market data for a particular geographic location is then uploaded at a block 514. The market data includes information for both brand and generic drugs for each pharmacy market type, i.e., independent, chain, and mass merchandiser, chain, and independent. The user therefore will have a total of six options from which to choose: brand-independent, brand-chain, brand-mass merchandiser, generic-independent, generic-chain, and generic-mass merchandiser. The user then selects one of the three options relating to generic drugs or one of the three options relating to brand drugs and the selection is uploaded into the system at a block 516. Based on the user's selection, a basic price is assigned at a block 518. In addition to receiving the monthly median market, the system may also perform market research and determine a forced price based on the market research. A block 520 determines if forced pricing is enabled. If forced pricing is not activated, the market price is equal to the basic price as shown at a block 522. If forced pricing is enabled, then the force price is determined at a block 524, and the market price is equal to the forced price as shown at a block 526. The forced price is determined based on trends in the market, news, research, and the like. Finally, a block 528 assigns the market price to the input value B 312, which may then be used to determine the final price as discussed above.

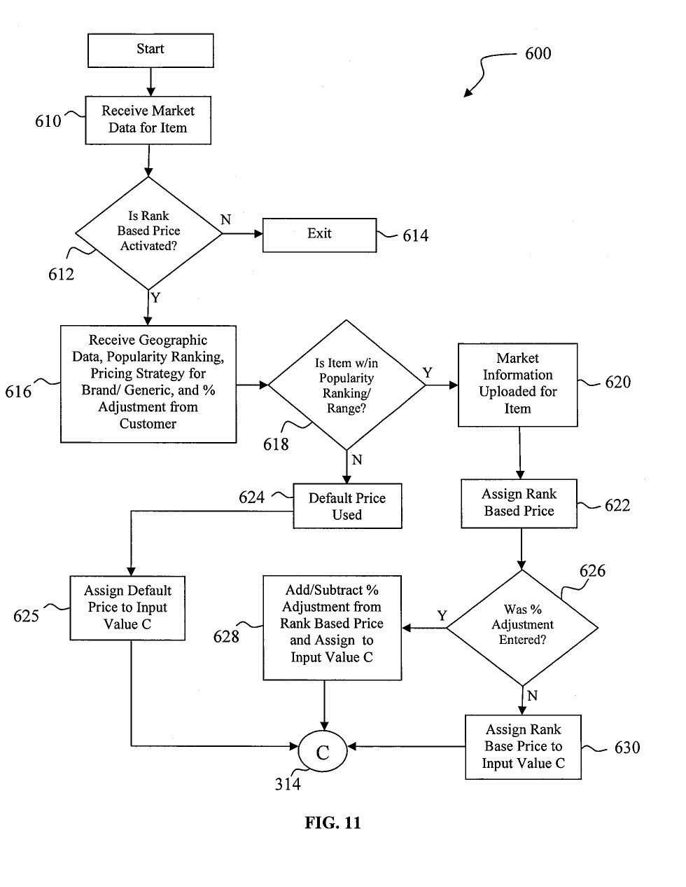

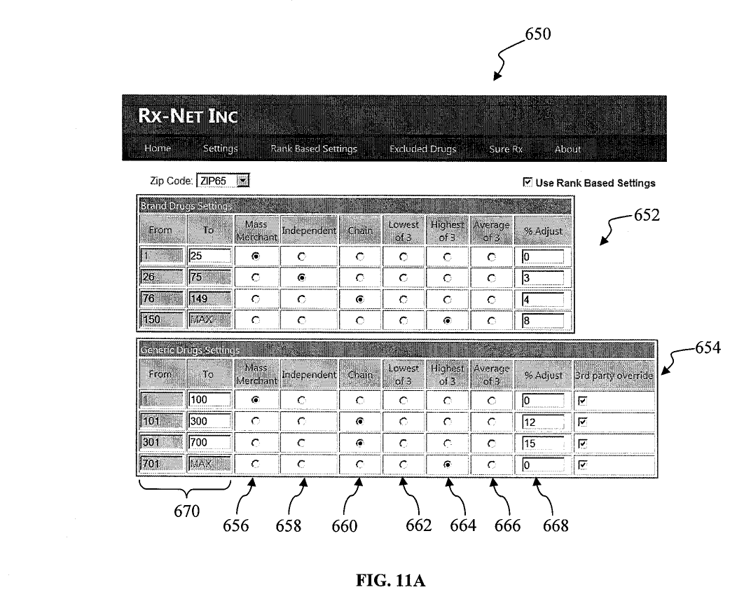

FIG. 11 is a flowchart 600 that illustrates the process by which a rank based price is determined. The rank based component of the system allows a pharmacy to choose a pricing strategy based on a drug's popularity. As shown in a rank based user interface 650 in FIG. 10A, six different strategies are available for both brand 652 and generic drugs 654. These six strategies include mass merchandiser 656, independent 658, chain 660, lowest of three 662 (i.e., the lowest price of mass merchandiser/independent/chain), highest of three 664, and the average of three 666. For example, for brand drugs ranked 1-25 in popularity, the pharmacy can choose to use the median price of the mass merchandisers. Similarly, the pharmacy may choose to use the highest median value for generic drugs ranked 701 and higher in popularity. Furthermore, the pharmacy or user has the option of adjusting its selections by adding or subtracting a user defined adjustment percentage 668.

Returning to FIG. 11, market data is received in a block 610. Next, at a block 612, the system determines if the rank based feature is activated. If the feature is not activated, the system exits at a block 614. At a block 616, the system receives information pertaining to the geographic market that has been selected by the pharmacy, the popularity rankings of interest to the pharmacy (the popularity rankings may be entered as ranges 670 as shown in FIG. 11A), the pricing strategy for both brand and/or generic drugs, and any percentage adjustment entered by the user. Next, at a block 618 the system determines if a drug included in the market data has a popularity ranking that falls within the popularity ranking or range selected by the user. If a drug's popularity ranking falls within the selected popularity ranking or range, then the pricing data for that drug is uploaded at a block 620, and the system assigns a rank based price at a block 622. Otherwise, if a drug does not fall within the popularity ranking or range, a default price may be used at a block 624, which is then assigned to input value C 314 at a block 625. The default price is based on a customer's preference, for example, a markup of 5% for chain brand drugs and +10% for chain generic drugs. If a ranked based price has been assigned, the system at a block 626 then determines if the user has entered a percent adjustment. If a percent adjustment was entered at the block 616, the system adds or subtracts an adjustment amount from the rank based price and assigns the adjusted rank based price to the input value C 314 in a block 628. The adjustment amount is equal to one plus the adjustment percentage, which may be a positive percentage for a price increase or negative percentage for a price reduction. If an adjustment percent was not entered at the block 616, then the rank based price is assigned to the input value C 314 at a block 630. The input value C 314 can then be used to calculate the final price as discussed above.

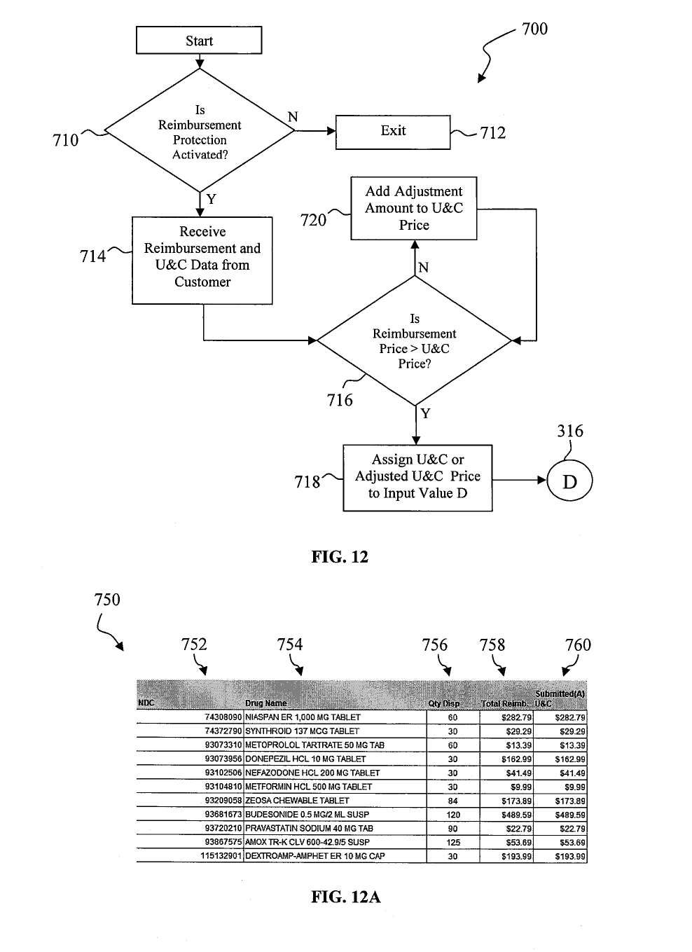

FIG. 12 is a flowchart 700 that demonstrates the process by which a reimbursement protection price is determined. The reimbursement protection product is a designed to keep usual and customary (“U&C”) pricing slightly higher than the maximum reimbursed amount a pharmacy could receive for its submissions to third parties for payment. U&C pricing is the actual retail price that a pharmacy charges to cash customers. If a pharmacy is reimbursed by an amount equal to its U&C price, the pharmacy is leaving money on the table because the third party, e.g., an insurance company, always pays the lowest of the maximum allowed cost (“MAC”) and the pharmacy's U&C price for each drug. For example, if a MAC for a drug is $12 and the pharmacy has a U&C price of $10, then the insurance company will pay $10. Thus, the pharmacy will forgo $2.

The reimbursement protection product will evaluate the U&C price and the amount reimbursed to a pharmacy each time the pharmacy provides the data. This can occur daily, weekly, or monthly. Because the reimbursement protection product is based on data provided by the pharmacy, it can be used to price drugs that are not included in the market data received by the system. FIG. 12A shows a sample of customer data 750 that may be provided to the system for each NDC 752 and associated drug name 754. The customer data 750 may include the quantity of the drug 756, a reimbursed amount 758, and the U&C price 760.

Turning now to FIG. 12, the system first determines at a block 710 if the reimbursement protection product is activated. If it is not activated, then the system exits the tool at a block 712. If the reimbursement protection tool is activated, the system loads reimbursement and U&C price data for a drug or set of drugs (generic and/or brand) that is provided by the pharmacy at a block 714. The data may be received daily, weekly, or monthly. In one embodiment, the MAC is known for a particular drug. The pharmacy provides a complete list of third party transactions that includes drugs reimbursed at their U&C price as well as drugs for which the pharmacy has received a MAC below the U&C price. The system then uses the data on those drugs where the MAC was below the U&C price to monitor the adjusted pricing on drugs that were subject to a price increase in the past because, at one time, the reimbursed amount was equal to U&C price. Alternatively, the pharmacy may elect to only provide data for those drugs for which the pharmacy has received a reimbursed amount less than the MAC. In another embodiment, the MAC for a drug is unknown by the pharmacy until the U&C price exceeds the MAC. Therefore, in this embodiment, the U&C and reimbursement data is provided on all drugs the pharmacy sells until the MAC is identified.

At a block 716, the system determines the relationship between the reimbursed amount and the U&C price for the drug or drugs reported by the pharmacy. If the U&C price is more than the reimbursed price, the U&C price is assigned to the input value D 316 at a block 718. If the U&C price is less than or equal to the reimbursed amount, the system will increase the U&C price at a block 720 by an adjustment amount based on a user defined percentage and assign the increased or adjusted U&C price to input value D 316. In one embodiment, the percentage is defined by the pharmacy to be in 1%, 3%, or 5% increments. The system will repeat the aforementioned steps each time the drug is included in a report sent by the pharmacy, thereby increasing the U&C price incrementally, until the U&C price of the drug is more than the most recently reported reimbursed amount, because at that point the reimbursed amount would be the MAC for the drug.

To ensure that the elevated U&C price on a particular drug remains appropriate, fluctuations in a pharmacy's acquisition cost, reimbursed amounts, or other data for a drug are monitored, and the U&C price is adjusted accordingly. For example, if the reimbursement protection tool determines that a particular U&C price for a drug should be increased in three increments from $10 to $11.58 and, 5 months later, the acquisition cost of the drug drops by 10%, then the elevated U&C price of $11.58 may be decreased by 10%. That is assuming that the new price of $10.42 is above the median market price for the drug in the geographic area. The U&C price may be decreased in one instance, or incrementally based on user defined percentages, such as 1%, 3%, and 5%, to reach the new price of $10.42. This new price is then monitored by the system and may be further increased or decreased as appropriate.

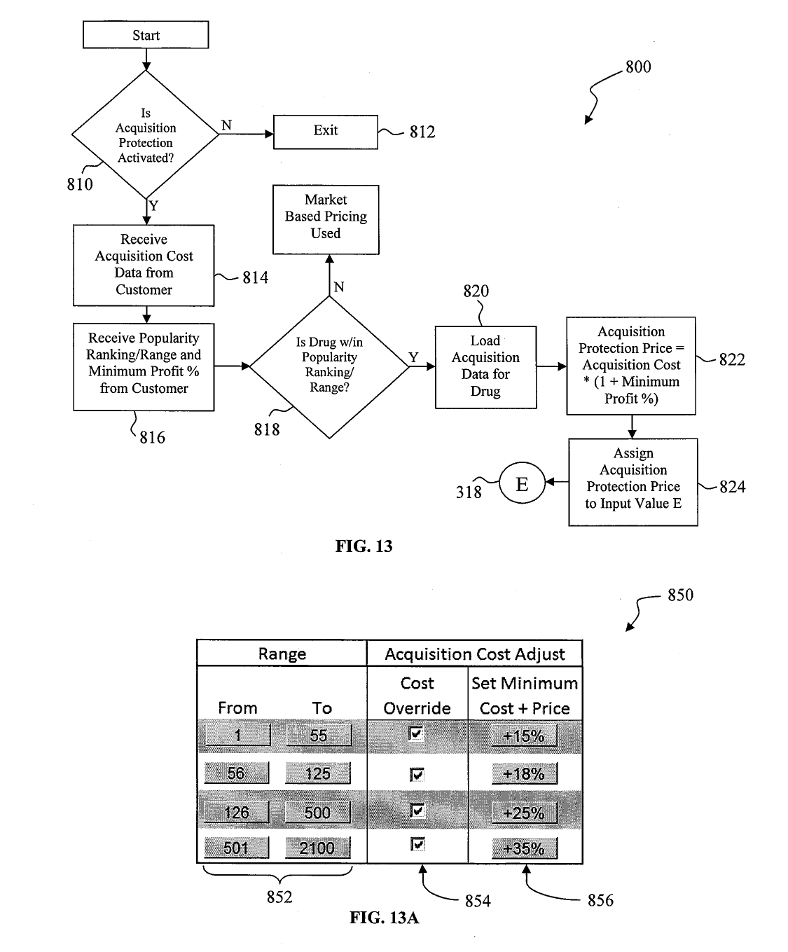

FIG. 13 is a flowchart 800 that illustrates the process by which an acquisition protection price is determined. The acquisition protection component relies on acquisition cost data provided by the pharmacy to the system on a daily, weekly, or monthly basis. The acquisition protection feature enables a pharmacy to set a minimum profit percent based on a drug's popularity ranking. Because the acquisition protection feature is based on data provided by the pharmacy, it can also be used to price drugs that are not included in the market data received by the system. As shown in the acquisition protection user interface 850 illustrated in FIG. 13A, the user can enter a popularity ranking range or ranges 852 and indicate with radial button(s) 854 if the user wants the acquisition cost to be activated for the selected range(s) 852. Furthermore, the user can set the minimum profit percent 858 for each popularity ranking range. For example, the pharmacy may set the minimum profit level for the top 55 most popular drugs at acquisition cost plus 15%. Thus, if drug A is ranked #25 in popularity and has a cost of $9.00, the price the system would transmit would be $10.35. The purpose of the acquisition protection component is to protect and maintain a user defined minimum price markup for a drug over its actual acquisition cost. Because the system receives market data that is based on the previous month's reported prices, the system is unable to adapt quickly to changes in cost in the market. For example, if the price of a drug goes up today, the system would not be able to immediately reflect this change in the pharmacy's acquisition cost as it may take the market one to two months to reflect the increase. However, if the acquisition protection component is enabled and the pharmacy submits the acquisition data to the system daily, the increased price of the drug will be incorporated into pharmacies pricing schedule within 24 hours. The acquisition protection component trumps all the other components that are lower in value than the value generated by the acquisition protection component.

Turning now to the flowchart 800, the system first determines if the acquisition protection feature is enabled by a user at a block 810. If it is not enabled, the system exits the feature at a block 812. If the feature is enabled, the system receives acquisition cost data for a drug or group of drugs from the pharmacy at a block 814. Next, the system loads at a block 816 the popularity ranking, which may be a range, and the minimum profit percentage defined by the user in the user interface 850 as shown in FIG. 13A. Alternatively, the popularity ranking or range may be automatically generated by the system. Next, at a block 818, the system determines if a drug contained in the data provided by the pharmacy has a popularity ranking that falls within the popularity ranking or range selected by the user. If it falls within the popularity ranking or range, then the acquisition data for that drug is uploaded at a block 820, otherwise the system uses default market based pricing. Next, a block 822 determines the acquisition protection price. The acquisition protection price is equal to the acquisition cost of the drug plus an adjustment amount. The adjustment amount is equal to the acquisition cost multiplied by one plus the minimum profit percentage. The acquisition protection price is then assigned to the input value E 318 at a block 824. The input value E 318 may then be used to determine the final price as discussed above.

### INDUSTRIAL APPLICATION

A method of creating a pricing schedule for use by a pharmaceutical pricing system of the present invention assigns pricing tables to various drugs based on a sliding scale that accounts for the benchmark price, different pricing components, and the slope quantity percent for a drug. In addition, a method of creating a pricing schedule for use by a pharmaceutical pricing system based on a markup or markdown price is presented that accounts for the benchmark price, different pricing components, and the slope quantity percent of a drug. These methods are advantageous because they assist pharmacies in establishing competitive and profitable pricing strategies. Further, the present invention enables pharmacies to design and implement a pricing strategy that sets prices for drug products that will provide a suitable return for the pharmacy. This method is used to set actual prices and not to predict prices or insurance costs.

The invention has been described in an illustrative manner in order to enable a person of ordinary skill in the art to make and use the invention, and the terminology used is intended to be in the nature of description rather than of limitation. It is understood that the invention may be practiced in ways other than as specifically described, and that all modifications, equivalents, and variations of the present invention, which are possible in light of the above teachings and ascertainable to a person of ordinary skill in the art, are specifically included within the scope of the appended claims.

We claim:

1. A method of creating a per quantity price for an item for use by a price management system, the method comprising:
utilizing a computer that includes relational database software to perform the steps of:
determining a final price (FP) for the item;
adjusting the FP by a slope quantity percent (SQP) that is based on a quantity of the item sold and on data stored on the computer to arrive at a pre-slope price (PSP);
identifying a benchmark price (BP) for the item;
calculating a base quantity percent (BQP) for the item based on the PSP and BP; and
providing the BQP for the item to the price management system for use in pricing orders for that item.

2. The method of claim 1, wherein the price management system is a pharmacy price management system and the item is a drug.

3. The method of claim 1, wherein the step of determining the final price further comprises the step of:
determining the final price of the item based on the greater of a secondary pricing strategy value and an item identity strategy value if available, otherwise the greater of the secondary pricing strategy value and a market value.

4. The method of claim 3 wherein the secondary pricing strategy value is based on a rank based pricing strategy value, a reimbursement strategy value, and/or an acquisition cost based strategy value.

5. The method of claim 3 wherein the secondary pricing strategy value is the greater of a rank based pricing strategy value, a reimbursement strategy value, and an acquisition cost based strategy value.

6. A method of maximizing a reimbursement price for an item for use by a price management system, the method comprising:
utilizing a computer that includes relational database software to perform the steps of:
receiving data, wherein the data contains a listing of items where a reimbursement amount associated with each item listed in the data is equal to a usual and customary (U&C) price for the item;
calculating an adjusted U&C price, wherein the adjusted U&C price is equal to the U&C price multiplied by an adjustment factor stored on the computer; and
outputting the adjusted U&C price to the price management system.

7. The method of claim 6, wherein the price management system is a pharmacy price management system and the item is a drug.

8. The method of claim 6, wherein the listing of items includes generic and brand items.

9. The method of claim 6, wherein the data is from a customer.

10. The method of claim 6, wherein the adjustment factor is based on a customer's preference.

11. The method of claim 6, wherein the data is received periodically.

12. A method of determining an acquisition cost based price for an item for use by a price management system, the method comprising:
utilizing a computer that includes relational database software to perform the steps of:
receiving data, wherein the data contains a listing of items and an acquisition cost and a popularity ranking associated with each item listed in the data;
retrieving an adjustment amount for a popularity range from stored data on the computer;
comparing the popularity ranking for each item in the data with the popularity range;
calculating the acquisition cost based price for those items where the popularity ranking is within the popularity range, wherein the acquisition cost based price is equal to the acquisition cost of the item multiplied by the adjustment amount and wherein the acquisition cost based price is not calculated for the item if the popularity ranking of the item does not fall within the popularity range; and
outputting the acquisition cost based price to the price management system.

13. The method of claim 12, wherein the price management system is a pharmacy price management system and the item is a drug.

14. The method of claim 12, wherein the data is received periodically.

15. The method of claim 12, further comprising the step of receiving an adjustment amount, wherein the adjustment amount is equal to one plus an adjustment percent.

16. The method of claim 12, wherein the listing of items includes generic and brand items.

17. The method of claim 12, wherein the acquisition cost data comes from one source and the popularity ranking data comes from a second source.

18. A method of determining a ranked based price for an item for use by a price management system, the method comprising:
utilizing a computer that includes relational database software to perform the steps of:
receiving data, wherein the data contains a listing of items, a popularity ranking for each item, and a median price for each item and for each market type;
retrieving a popularity range, a pricing strategy, and an adjustment amount from stored data on the computer;
comparing the popularity ranking for each item in the data with the popularity range;
calculating a ranked based price based on the popularity range, the pricing strategy, and the adjustment amount for those items where the popularity ranking is within the popularity range, wherein the ranked based price is not calculated for an item if the popularity ranking of the item does not fall within the popularity range; and
outputting the ranked based price to the price management system.

19. The method of claim 18, wherein the price management system is a pharmacy price management system and the item is a drug.

20. The method of claim 18, wherein the data is received periodically.

21. The method of claim 18, wherein the listing of items includes generic and brand items.

22. The method of claim 18, further comprising the step of receiving an adjustment amount, wherein the adjustment amount is based on an adjustment percent.

23. The method of claim 18, wherein market type comprises mass merchandisers, independent retailers, and chain retailers.

24. The method of claim 23, wherein the pricing strategy is selected from a median price at which the item is sold by mass merchandisers in the market, a median price at which the item is sold by independent retailers in the market, a median price at which the item is sold by chain retailers in the market, a lowest median price of the item in the market, a highest median price of the item in the market, and an average median price of the item in the market.

25. The method of claim 24, wherein the pricing strategies chosen for generic items and brand items are different.

26. The method of claim 24, wherein there are multiple popularity ranges and there is a separate pricing strategy for each popularity range.
